(19) United States
(12) Patent Application Publication
(10) Pub. No.: US 2006/0099510 A1
(43) Pub. Date: May 11, 2006

(54) Electrically conductive bonding agent

(76) Inventors: Herbert Naarmann, Frankenthal (DE); Franz Josef Kruger, Eppstein (DE); Michael Stolzenberg, Dessau (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/521,664

(22) PCT Filed: Jul. 16, 2003
(86) PCT No.: PCT/EP03/07725

§ 371 Date: Oct. 17, 2005

(30) Foreign Application Priority Data
Jul. 17, 2002 (DE) 102 32 379.8

(51) Int. Cl. H01B 1/20; H01B 1/24; H01M 4/62

(52) U.S. Cl. 429/232; 252/500; 252/511; 429/217

(57) ABSTRACT

The invention relates to an electrically conductive bonding agent, an electrode, and a secondary battery comprising such a bonding agent, and a method for the production of such an electrode. The inventive bonding agent is characterized by the fact that it comprises an aqueously dispersed fluoride polymer and an amine salt or ammonium salt of a perfluorcarboxylic acid

The invention concerns an electrically conductive adhesive, in particular for current collectors, an electrode and secondary battery comprising such an adhesive, and further a method for the production of such an electrode. In particular, the invention relates to an adhesive for electrodes in lithium batteries, including lithium-polymer batteries.

In the production of lithium batteries, the problem consists in the production of the capacity-determining electrodes, of both the anode and the cathode. The electrodes are electrically conductive materials on the basis of electrically conductive polymers and/or metal foils (current collectors) that are coated with active anode or cathode materials. Hereby, current collector materials made of copper and aluminum cause particular problems.

The adhesive is supposed to guarantee the adherence of the active anode and cathode material to the respective current collectors, i.e. a detachment during battery fabrication and also during battery operation, i.e. the cycling (charging/discharging) with more than 500 cycles, may not occur.

To solve the problem, electrodes with metal oxides (SnO₂, In-oxide) (U.S. Pat. No. 5,616,437) were proposed in the state of the art.

Furthermore, polymer binders on the basis of polyacrylic acid, if necessary with conductive additives (U.S. Pat. No. 5,463,179) are disclosed in U.S. Pat. No. 5,441,830, U.S. Pat. No. 5,464,707, and U.S. Pat. No. 5,824,120.

U.S. Pat. No. 5,441,830 and U.S. Pat. No. 5,464,707 describe the production of adhesives for conductive plastic films that are to be utilized as current collectors. Hereby, the monomers are provided with a conductive additive, laminated to the films, and polymerized through electron beams. Acrylic acid, chloroacrylic acid, bromoacrylic acid, or vinylsulfonic acid are used as monomers. Polyacrylic acid individually or in a mixture with polyethylene oxide is also utilized as polymer binder for the adhesive.

The use of adhesives on the basis of polyolefins, polyvinyl ethers, polystyrene, or rubbers on the basis of SBR (styrene-butadiene rubber) is the subject matter of U.S. Pat. No. 5,542,163 and U.S. Pat. No. 5,798,190 (corresponding to EP 0 397 523 B1). In general, the presence of carboxyl groups or functional groups (through copolymerization with acrylic acid or vinyl acetate) is described as advantageous. According to U.S. Pat. No. 5,542,163, the adhesives are utilized in electrophotographic toners. According to U.S. Pat. No. 5,798,190, a roughening of the surface through etching with HF/HNO₃ is necessary before the application of the adhesive.

DE 198 43 131 A1 concerns a method for the production of an electrode for a secondary element based on lithium that is obtained through mixing of an active material, a conductive additive, a binder, and a softener. Epoxidized soybean oil or dibutyl phthalate serve as binder.

However, all adhesives described so far show serious disadvantages when it comes to the adherence of active anode materials on the basis of carbons that are capable of intercalation or of active cathode materials on the basis of transition metal oxides with intercalated Li to copper or, primarily, aluminum current collectors.

The adherence is either not there at all or so inadequate that during the discharge/charge process of the battery, a distinct failure behavior occurs already after a few cycles and the system is not suitable for the market.

Consequently, it is an object of the present invention to improve the adherence of active electrode materials to conventional current collectors and, in particular, copper or aluminum current collectors. It is another object of the present invention to provide electrodes and secondary batteries whose active electrode materials exhibit an improved adherence to conventional current collectors and, in particular, copper or aluminum current collectors.

This object may be solved by an adhesive according to claim 1, as well as by an improved electrode and secondary battery according to the claims 19 and 30, respectively, and a new production method for improved electrodes according to claim 32.

Further aspects, advantages, and effects of the present invention are solved by preferred embodiments of the adhesives, electrodes, secondary batteries, or by preferred production methods for electrodes according to the dependent patent claims.

In the following, preferred embodiments of the adhesives, electrodes, and secondary batteries according to the invention, as well as of the production method for electrodes according to the invention are described.

The electrically conductive adhesive according to the invention comprises an aqueously dispersed fluoropolymer and an amine or ammonium salt of a perfluorocarboxylic acid. The utilized fluoropolymer is preferably inert toward the processes and the reactions at an electrode and in a battery system.

Fluoropolymers corresponding to the literature Ullmann's Encyclopedia of Industrial Chemistry, Vol. A 11, pp. 394 -429, 1997, publisher Verlag VCH, Weinheim, that are present in aqueously dispersed form, are suitable. The utilized monomers of the fluoropolymers may be preferably, but not exclusively selected from the group consisting of tetrafluoroethylene (TFE), hexafluoropropylene (HFP), vinylidene fluoride (VDF), and perfluorovinyl ether. It is further preferred to utilize copolymers or terpolymers from one or more of these or also other fluoropolymers. Among others, they may be, if necessary, fluoroelastomers and, in particular, elastomers on the basis of the foregoing polymers.

Fluoropolymers utilizable in preferred embodiments are, for example, terpolymers from TFE/HFP/VDF (THF), copolymers from TFE/HFP (FEP), or perfluorooxy-copolymers from, for example, TFE and perfluorovinyl ether (PFA). The fluoropolymers mentioned in Table 1 may be utilized as commercially available products (Dyneon house organ (USA) 98-0504-1025 (CPI)). In Table 1, these are further characterized with regard to their solids content, pH value, melting point, their particle size, viscosity, and the added additives such as emulsifiers.

TABLE 1

| | | THV | THV | THV | FEPX | PFAX |
|---|---|---|---|---|---|---|
| Test | Parameter | 340 D | 340 C | 810 D | 6300 | 6910 N |
| ASTM | Solids | 34 | 50 | 32 | 50 | 50 |
| D4441 | content [%] | | | | | |
| ASTM | pH | 7 | 9.5 | 2 | 8 | ˜7 |
| E70 | | | | | | |
| ASTM | Melting | 145 | 145 | 165 | 255 | 310 |
| D4591 | point | | | | | |
| | [° C.] | | | | | |
| ISO | Particle size | 90 | 90 | 90 | 150 | 235 |
| 13321 | [nm] | | | | | |
| DIN | Viscosity | 20 | 76 | 76 | 65 | 21 |
| 54453 | [mPas] | | | | | |
| Emulsifier | | Ion. | Ion. | Ion. | Non- | Non- |
| | | | | | ion. | ion. |

Ion. = Ammonium pentadecafluorooctanoate
Non-ion. = Copolymer vinyl pyrrolidone/vinyl acetate

In a preferred embodiment, advantages arise particularly through the use of fluoropolymers with a melting point of 140° C. or more, further preferred of about 140 to 310° C., for example by use of the TFE/HFP/VDF-terpolymers Dyneon 340® and Dyneon THV 810® (produced by Dyneon GmbH & Co. KG), since consequently failure mechanisms due to increased temperatures may be better eliminated.

The fluoropolymer is preferably present in the adhesive according to the invention with an amine or ammonium salt of a perfluorocarboxylic acid dispersed in water. Suitable perfluorocarboxylic acids may be selected from mono- or dicarboxylic acids which preferably have more than 6 C-atoms. To solve the object according to the invention, for example an amine of a perfluorocarboxylic acid selected from the group consisting of RNH₂, H₂NR-NH₂, and R-(NH₂)₃ may be utilized in the aqueous dispersion, whereby R preferably stands for alkyl, aryl, or cycloalkyl.

If necessary, a dispersing agent may in addition be added to the aqueous dispersion of the fluoropolymer to improve the dispersion. An example of such a dispersing agent is a copolymer on the basis of vinyl pyrrolidone/(meth)acrylic acid that is optionally used aqueous as ammonium salt.

If necessary, an additional conductive material is added to the adhesives according to the invention to still increase the contact conductivity. Such additionally utilized conductive materials may be selected from the group consisting of carbon black, graphite, and conductive organic materials such as electrically conductive polymers.

Furthermore, additional additives such as MgO, Al₂O₃, B₂O₃, H₃BO₃ and similar conventionally used additives may also be dispersed in the aqueous adhesive dispersions. Further preferred additives are alizarin and other metal complex formers that may be used as powder mixtures or ammoniacal solutions, if necessary as dispersion. These added additives may, among other things, serve to further improve the contacting.

The additives are advantageously added microencapsulated. The microcapsules may be produced as described in Ullmann's Encyclopedia of Industrial Chemistry Vol. A 16, pp. 575-587 (1990), publisher Verlag Wiley-VCH/Weinheim. The size of the microcapsules is preferably 0.01 to 1,000 μm and further preferred 0.1 to 150 μm. The microcapsules may have a polymer wrapping that for example comprises PVDF. This is preferably 0.001 to 100 μm and further preferred 0.01 to 10 μm thick. The amount of the microcapsules utilized per electrode is preferably 0.5 to 15 percent by weight per electrode.

The aqueous adhesive dispersion may for example comprise about 5 to 50 percent by weight, preferably 5 to 30 percent by weight, and in particular 5 to 20 percent by weight of polymers. Furthermore, the amounts of the electrically conductive additives such as carbon black, graphite, polyaniline, polypyrrole or the like, in case these are added to the adhesive dispersion, are about 2 to 30 percent by weight, preferably about 4 to 20 percent by weight, and in particular about 5 to 15 percent by weight.

In case MgO is utilized as additive, the amounts thereof are preferably about 0.5-5 percent by weight.

Next, the preferred embodiments of the electrode according to the invention are explained. The basic set-up of an electrode comprises a current collector, an adhesive applied thereto, and an active electrode material that is firmly bonded to the current collector via the adhesive. According to the invention, for this purpose, an adhesive according to the invention, as it is described in detail in the foregoing, is utilized.

The current collectors utilized in the electrode according to the invention may comprise any current collectors known from the state of the art. The current collectors are preferably shaped in form of films, fibers, mats, or meshs. Furthermore, they may exhibit different surface structures in which they are, however, not limited. The current collectors preferably exhibit a smooth, rough, or perforated surface.

The current collectors may comprise the following materials:
a) electrically conductive polymers, e.g. polypyrrole, polyaniline, polythiophene or the like, or
b) filled synthetic materials that are made electrically conductive by the filler material such as carbon black, graphite, metal powder, and whisker, or
c) metals such as silver, copper, tin, aluminum, titanium, chromium, or nickel.

However, in special embodiments the metals may also be present as coatings on plastic films or other materials.

The active electrode material that is firmly bonded to the current collector by means of the adhesive may be either an active anode or cathode material. The active anode or cathode materials together with the current collectors to which they are applied, form the electrode, i.e. the anode or cathode of, for example, a secondary battery and, in particular, a lithium battery or a lithium-polymer battery. As active electrode material for the cathode are used, for example, transition metal oxides such as Co^{III}-oxide, Ni^{II}-oxide, Mn^{IV}-oxide, tungstate, molybdate, titanate, Fe^{III}-phosphate, ferrate, or chromate. Preferably, these are present, in each case, in a Li-containing form, e.g. as LiCoO₂, LiNiO₂, LiMn₂O₄ etc. This applies in particular in the event the active cathode material is utilized in an electrode for lithium batteries.

As active electrode material for the anode are used, for example, graphite, other carbon modifications, carbon black, or also fibers such as carbon fiber. Here as well, the form capable of intercalation is preferred in each case by use in electrodes for lithium batteries, in particular for lithium.

In a preferred embodiment, a further important component of the anode or cathode material is the adhesive according to the invention that is mixed with this material here. Consequently, the adhesive may cause the adherence of the electrode material to the current collector without the need for application of an additional adhesive to the current collector as an extra layer.

In a further preferred embodiment of the invention, the adhesive according to the invention is applied to the current collector as a film before the active electrode material is applied, and then occurs a drying. An electrode according to the invention that is developed in such a way, consequently exhibits a multilayered electrode structure comprising a current collector layer, an adhesive layer, and a layer of the active electrode material.

Further details and developments of the electrode according to the invention become apparent from the examples.

The adherence or the binding of the active electrode materials such as the transition metal oxides or the carbons should satisfy the following conditions:
1. an adherence to the current collector that is also stable over longer cycling (preferably >200 cycles, in particular >500 cycles), i.e. does not show detachment; and
2. is so stable that mechanical stress such as buckling or molding pressure does not lead to cracks, detachments or displacements from the current collector.

A further aspect of the present invention is a secondary battery comprising at least one anode and one cathode and at least one separator, whereby at least one electrode of the secondary battery is an electrode developed according to the invention in accordance with the foregoing description.

The secondary battery according to the invention may be preferably developed as a lithium or lithium-polymer battery through suitable selection of the active anode or cathode material as well as through suitable selection of the separator. The separator may be developed as solid polymer-electrolyte material with additional components.

According to the invention, the electrode according to the invention or the electrode utilized in the secondary battery according to the invention may be produced by a method that comprises the following steps:
providing an aqueous dispersion of an adhesive according to the invention;
producing a mixture of the aqueous dispersion with the active electrode material;
applying the mixture to a surface of a current collector; and
drying of the applied mixture.

To improve the adherence of the active electrode material to the current collector, the method may additionally comprise the step of degreasing the current collector before the step of applying the mixture comprising the aqueous dispersion of the adhesive.

Further details according to the invention are apparent from the examples. The given quantities are percent by weight or mass proportions.

### EXAMPLE 1

300 parts of a 20% aqueous dispersion with a fluoropolymer (Dyneon THV 220®) on the basis of TFE, HFP, and VDF with ammonium pentadecafluorooctanoate as perfluorocarboxylic acid-ammonium salt are mixed with a mixture of 10 parts of carbon black (Ensaco), 1 part of polyvinyl pyrrolidone/acrylic ammonium salt (molecular weight 15-20,000) and 10 parts of water in a dispersing agent and applied as film to a Cu-foil and Al-foil degreased through washing with acetone (blade coating: 100 nm thick). The foils are heated over the course of 1 hour to 150° C. and left at this temperature for 30 minutes. Afterwards, the foils with the film are tested. The film adheres to both foils, it is buckling and scratch resistant and solvent resistant: N-methyl pyrrolidone (NMP), toluene, propylene carbonate, diethyl carbonate showed after 24 hours of exposure at 30° C. no effect at all: e.g. dissolving, rippling, or infiltrating, i.e. detaching from the foil.

### EXAMPLE 2

10 parts of carbon black (Ensaco) are intensely ground with a solution of 1 part of polyvinyl pyrrolidone/methacrylic acid-ammonium salt (molecular weight 10 to 15,000) and 10 parts of water in a grinding mill for 90 minutes at room temperature and then, with further stirring, 200 parts of an aqueous 30% dispersion of Dyneon THV 220® are added over the course of 1 hour. The obtained dispersion is then applied to the degreased surface of a Cu- and Al-collector foil and dried (analogous Example 1). Afterwards, the active electrode materials are applied. The anode material is applied to the Cu-foil and the cathode material to the Al-foil, each with a thickness of 50 μm, and laminated at 100-110° C. A firm composite is generated that is buckling resistant and may be wound.

### EXAMPLE 3

The aqueous dispersion was produced according to Eample 1, however, the dispersion additionally comprises 2 percent by weight of MgO based on the solids content.

After the analogous processing and testing, no changes compared to the film from Example 1 were observed. The solubility test resulted therein that with exposure to NMP (N-methyl pyrrolidone), after 7 days at room temperature as well no dissolving or detaching effects were observed.

### EXAMPLE 4

The aqueous dispersion was produced according to Example 1, however, now 5 parts of carbon black and 10 parts of MCMB® (meso carbon micro beads) were utilized. The processing and testing occurred as in Example 1. Negative effects were not observed. In this example as well, the adhesive according to the invention exhibited a similarly good solvent resistance and adherence characteristic.

To degrease the current collectors, a surfactant (Lit: Surfactants Ullmann's Encyclopedia of Industrial Chemistry Vol A 25, pp. 747-814 [1994] publisher Verlag VCH, Weinheim), for example on the basis of a copolymer of vinyl pyridine with methacrylic acid (2%, aqueous), was used as wash solution for a dipping bath (70° C.); the residence time was 30 sec.; and, afterwards, drying occurred in a infrared heating section. An Al-foil (10 μm thick) and a Cu-foil (8 μm) were used as collector.

### EXAMPLES 5 to 9

The Examples 5 to 9 were carried out analogous Example 1. The composition of the adhesives utilized in the examples is evident from the succeeding Table 2. The indicated quantities refer to parts by weight.

TABLE 2

| | | Conductive | Dispersing | |
|---|---|---|---|---|
| Ex. | Dispersion | mat. | agent | Additive |
| 5 | Dyneon THV 340 ® | Ensaco ® | PVP/MM- | H₃BO₃ |
| | 300 parts/20% | 10 parts | ester/MAS | 5 parts |
| | | | 10 parts | |
| 6 | Dyneon THV 340 ® | Kropfmuhl- | Luviskol | H₃BO₃ |
| | 300 parts/20% | graphite | K80 ® | 10 parts |
| | | 10 parts | 5 parts | |
| 7 | Dyneon THV 340 ® | MCMB ® | Luviskol | H₃BO₃ |
| | 300 parts/20% | 10 parts | K30 ® | 10 parts |
| | | | 10 parts | |
| 8 | Dyneon THV 340 ® | Ensaco ® | Luvitec VP | Alizarin |
| | 300 parts/20% | 10 parts | MA 91 W | 3 parts |
| | | | 7.5 parts | |
| 9 | Dyneon THV 810 ® | Ensaco ® | Luviskol | MgO, microen- |
| | 300 parts/20% | 10 parts | K80 ® | capsulated* |
| | | | 5 parts | 10 parts |

*microencapsulated in a microcapsule with PVDF-cover; capsule diameter is on average 0.01 to 0.1 mm (corresponding to 10 to 100 μm), the cover mass is about 15 percent by weight
PVP/MM-ester/MAS: terpolymer of vinyl pyrrolidone/methacrylic acid ester/methacrylic acid in a ratio of 60/25/15 (in percent by weight based on the whole molecule)
Luviskol: homopolymer from vinyl pyrrolidone; the number after the K indicates the K-value: 80 corresponds to a molecular weight of about 80,000, 30 to a molecular weight of about 30,000
Luvitec VP MA 91 W: copolymer from 90 percent by weight of vinyl pyrrolidone and 10 percent by weight of Na-methacrylate

The testing of the adhesives according to the Examples 5 to 9 resulted therein that in the solubility test, a dissolving or detaching effect was not observed as well.

### COMPARATIVE EXAMPLE 1

It was operated as in Example 1, with the exception that the dispersion of the terpolymers according to the invention was replaced by a solution of PVDF/HFP (Kynar 2801®, 10% in NMP and with 10% carbon black added), in order to coat a electrode foil (Al) therewith. Even after intensive drying (250° C., 5 hours), a re-swelling and, in part, an infiltration of the adhesive layer was still observed.

### COMPARATIVE EXAMPLE 2

It was operated as in Example 1, with the exception that it was operated with a Li-polysilicate according to U.S. Pat. No. 5,580,686 as adhesive. Firmly adhering coatings were formed on the Al-foil, however, during battery operation, an infiltration and detachment of the layer from the foil occurred.

However, coatings produced in accordance with the method according to the invention did not show these failure mechanisms.

### EXAMPLE 10

300 parts of a 340% aqueous dispersion with a fluoropolymer (Dyneon THV 340 D®) on the basis of TFE, HFP, and VDF with ammonium pentadecafluorooctanoate are mixed with an alizarin mixture of 10 parts of carbon black (Ensaco®), 2 parts of H₃BO₃, 5 parts of alizarin, and 1 part of polyvinyl pyrrolidone/methacrylic ammonium salt (molar weight 15-20,000) and 10 parts of water in a dispersing agent and applied as film to a Cu-foil and Al-foil degreased through washing with acetone (blade coating: 100 nm thick) . The foils are heated to 180° C. over the course of 1 hour and left at this temperature for 30 minutes. Afterwards, the foils with the film were tested.

The film adheres to both foils, it is buckling and scratch resistant and solvent resistant: N-methyl pyrrolidone (NMP), toluene, propylene carbonate, diethyl carbonate showed after 24 hours of exposure at 30° C. no effect at all: e.g. dissolving, rippling, or infiltrating, i.e. detaching from the foil.

### EXAMPLE 11

10 parts of carbon black (Ensaco®) and 1 part of H₃BO₃ are intensely ground with a solution of 1 part of polyvinyl pyrrolidone/methacrylic acid-ammonium salt (molecular weight 10 to 15,000) and 10 parts of water in a grinding mill for 90 minutes at room temperature and then, with further stirring, 200 parts of an aqueous 50% dispersion of Dyneon THV 340® are added over the course of 1 hour.

The obtained dispersion is then applied to the degreased surface of a Cu- and Al-collector foil and dried (analogous Example 1).

Afterwards, the active electrode materials are applied. The anode material is applied to the Cu-foil and the cathode material to the Al-foil, each in a thickness of 30 μm, and laminated at 100-110 ° C. A firm composite is generated that is buckling resistant and may be wound around a mandrel with a diameter of 3 mm.

### EXAMPLE 12

It was operated according to Example 10, however, a 1:1 volume-mixture of Dyneon FEPX 6300® with PFAX 6910 N® as 50% dispersion was utilized instead of the 34% aqueous dispersion of Dyneon THV 340 D®.

The dispersion, to which the additives H₃BO₃ and alizarin were added, is processed analogous Example 10. In this case as well, a firmly adhering film is obtained that after the tests according to Example 1 did not show any detachment from the foil (Cu- and Al-foil) and infiltration.

1. An electrically conductive adhesive for the improvement of the adherence of active electrode materials to conventional current collectors, comprising an aqueously dispersed fluoropolymer, an amine or ammonium salt of a perfluorocarboxylic acid, and a conductive material.

2. The adhesive according to claim 1, wherein the fluoropolymer is a terpolymer.

3. The adhesive according to claim 1, wherein the fluoropolymer is selected from the group consisting of tetrafluoroethylene (TFE), hexafluoropropylene (HFP), vinylidene fluoride (VDF) and perfluorovinylether.

4. The adhesive according to claim 1, wherein the perfluorocarboxylic acid is a mono- or dicarboxylic acid that has more than 6 carbon atoms.

5. The adhesive according to claim 1, wherein the amine is selected from the group consisting of RNH₂, H₂NR-NH₂, and R-(NH₂)₃, wherein R is alkyl, aryl, or cycloalkyl.

6. The adhesive according to claim 1, further comprising a dispersing agent.

7. The adhesive according to claim 6, wherein the dispersing agent is a vinyl pyrrolidone/(meth)acrylic acid copolymer or ammonium salt thereof.

8. The adhesive according to claim 1, wherein the conductive material is selected from the group consisting of carbon black, graphite, and electrically conductive organic materials.

9. The adhesive according to claim 1, wherein the polymer content is 5-50 percent by weight.

10. The adhesive according to claim 1, wherein the amount of the conductive material present is 2-30 percent by weight.

11. The adhesive according to claim 1, further comprising one or more additives selected from the group consisting of MgO, Al₂O₃, B₂O₃, H₃BO₃ and alizarin.

12. The adhesive according to claim 11, the additive content is 0.5-5 percent by weight.

13. (canceled)

14. An electrode comprising a current collector, an adhesive according to claim 1, and an active electrode material.

15. The electrode according to claim 14, wherein the electrode has a multilayer set-up.

16. The electrode according to claim 14, wherein the active electrode material is an active cathode material.

17. The electrode according to claim 16, wherein the active electrode material comprises a transition metal oxide, a tungstate, a molybdate, a titanate, a ferrate, or a chromate.

18. The electrode according to claim 17, wherein the transition metal oxide is a Li/transition metal mixed oxide.

19. The electrode according to claim 16, wherein lithium is present intercalated in the active cathode material.

20. The electrode according to claim 14, wherein the active electrode material is an active anode material.

21. The electrode according to claim 20, wherein the active anode material is selected from the group consisting of graphite, carbon, carbon black, and fibers.

22. The electrode according to claim 20, wherein the active anode material is present in a form capable of intercalation.

23. The electrode according to claim 14, wherein the current collector comprises an electrically conductive polymer, a synthetic material filled with an electrically conductive material, or a metal.

24. The electrode according to claim 14, wherein the current collector is shaped in form of a film, fiber, mat, or mesh.

25. A secondary battery comprising at least one anode and one cathode, and at least one separator, wherein the at least one anode or cathode is an electrode according to claim 14.

26. The secondary battery according to claim 25, wherein the battery is a lithium or lithium-polymer battery.

27. A method for the production of an electrode comprising a current collector, an adhesive, and an active electrode material, comprising the following steps:
providing an aqueous dispersion of an adhesive according to claim 1
producing a mixture of the aqueous dispersion with an active electrode material;
applying the mixture to a surface of a current collector; and
drying the applied mixture.

28. The method according to claim 27, further comprising the step of degreasing the current collector before the step of applying the aqueous dispersion of the adhesive.

29. The adhesive according to claim 1, wherein the fluoropolymer has a melting point of 140° C. or more.

30. The adhesive according to claim 11, wherein the additive is microencapsulated.

31. The adhesive according to claim 30, wherein the diameter of the microcapsules is 0.01 to 1000 microns.

32. The adhesive according to claim 30, wherein the polymer wall of the microcapsules has a thickness of 0.001 to 100 microns.

33. The adhesive according to claim 30, wherein the microcapsule amount polymer wall of the microcapsules has a thickness of 0.001 to 100 microns.

34. The electrode according to claim 17, wherein the active electrode material comprises a transition metal oxide selected from the group consisting of Co^{III}-oxide, Ni^{II}-oxide and Mn^{IV}-oxide.

35. The electrode according to claim 22, wherein the active anode material is present in a form capable of intercalation with lithium.
